(19) United States
(12) Patent Application Publication
(10) Pub. No.: US 2011/0012937 A1
(43) Pub. Date: Jan. 20, 2011

(54) LIQUID CRYSTAL DISPLAY APPARATUS

(75) Inventors: Toshiki ONISHI, Osaka (JP); Takahiro KOBAYASHI, Okayama (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/837,289

(22) Filed: Jul. 15, 2010

(30) Foreign Application Priority Data
Jul. 17, 2009 (JP) 2009-169122

(51) Int. Cl. G09G 5/10; G09G 3/36

(52) U.S. Cl. 345/690; 345/102

(57) ABSTRACT

A liquid crystal display apparatus that can alter the chromaticity of a display image in a white backlight by performing a drive control of light sources. The liquid crystal display apparatus (100) has: a liquid crystal panel (101) that displays images; a backlight (102) that has semiconductor light sources (106) and that illuminates the liquid crystal panel (101); a driving section (103) that drives the semiconductor light sources (106); a controlling section (104) that controls the driving section (103) so as to realize a desired, temporally-averaged chromaticity by switching between a plurality of chromaticities per switching time; and a signal brightness level detecting section (105) that detects the feature amount of an image. The controlling section (104) controls at least one of the chromaticity and brightness according the feature amount detected in signal brightness level detecting section (105).

### CROSS REFERENCE TO RELATED APPLICATIONS

This application is entitled to (or claims) the benefit of Japanese Patent Application No. 2009-169122, filed on Jul. 17, 2009, the disclosure of which including the specification, drawings and abstract, is incorporated herein by reference in its entirety.

### TECHNICAL FIELD

The technical field relates to a liquid crystal display apparatus.

### BACKGROUND ART

There is a type of a liquid crystal display apparatus that illuminates a liquid crystal panel using an LED backlight formed by arraying light emitting diodes (LED's).

Generally, a liquid crystal panel has a characteristic that the transmittance varies according to the wavelength of light, due to the influence of the liquid crystal, polarizing plate, color filter and so on. Therefore, when the brightness level of an input video signal is low, there are cases where a bluish tinge in black color is seen in a display image on a liquid crystal panel.

To deal with this problem, some liquid crystal display apparatuses perform a color temperature control of display images.

For example, a conventional liquid crystal display apparatus disclosed in Patent Literature 1 controls the color temperature of an LED backlight according to the brightness level of an input video signal. To be more specific, when the brightness level of an input video signal lowers, for example, the brightness level of blue LED's, which are the B light source, decreases below the brightness levels of the light sources of other colors, so that black dolor with a bluish tinge in a display image is corrected.

### SUMMARY

### Technical Problem

The LED backlight controlled in the above conventional liquid crystal display apparatus employs a configuration including light sources of different colors. There are LED backlights in which LED's of a plurality of colors (for example, three colors of R (red), G (green) and B (blue)) are arrayed, and LED backlights (i.e. white LED backlights) in which white LED's are arrayed. However, few proposals have been made on an active basis as to how to control the color temperature (or chromaticity) in case where use of a white LED backlight is assumed. The same applies to a case where light sources such as laser units or organic electro-luminescence (“OLE”) units other than LEDs are used as light sources for the backlight.

The object is to provide a liquid crystal display apparatus that can alter the chromaticity of a display image by performing a drive control of light sources in a white LED backlight.

### Solution to Problem

In order to achieve the above object, the liquid crystal display apparatus includes: a liquid crystal panel that displays an image; a backlight that has a semiconductor light source and that illuminates the liquid crystal panel; a driving section that drives the semiconductor light source; a controlling section that controls the driving section so as to realize a desired, temporally-averaged chromaticity by switching between a plurality of chromaticities per switching time; and a detecting section that detects a feature amount of at least one of the image, the semiconductor light source and ambient light, and the controlling section controls at least one of chromaticity and brightness according to the feature amount detected by the detecting section.

### ADVANTAGEOUS EFFECTS

A liquid crystal display apparatus according to the present invention can alter the chromaticity of a display image by performing a drive control of light sources in a white LED backlight.

### BRIEF DESCRIPTION OF DRAWINGS

FIG. 1 is a block diagram showing a configuration of a liquid crystal display apparatus according to Embodiment 1 of the present invention;

FIG. 2 shows arrays of white LED's in a white LED backlight according to the present embodiment;

FIG. 3 shows an example of an LED drive pulse according to the present embodiment;

FIG. 4 is a flowchart showing an example of an LED drive pulse control according to the present embodiment;

FIG. 5 is a flowchart showing content of processing in step S200 of FIG. 4;

FIG. 6A is a chromaticity diagram showing a chromaticity adjustment range and a blackbody trajectory of LEDs according to the present embodiment, in which a blackbody trajectory and an isotemperature line in an xy chromaticity diagram are shown;

FIG. 6B is a chromaticity diagram showing a chromaticity adjustment range and a blackbody trajectory of LEDs according to the present embodiment, in which a chromaticity adjustment range of white LEDs is shown;

FIG. 7 is a chromaticity diagram showing an example of a relationship between LED drive pulse current values and chromaticity according to the present embodiment;

FIG. 8A illustrates a specific example of an LED drive pulse control according to the present embodiment, in which an example of an LED drive pulse is shown;

FIG. 8B illustrates a specific example of an LED drive pulse control according to the present embodiment, in which another example of an LED drive pulse is shown;

FIG. 9 shows another example of an LED drive pulse according to the present embodiment;

FIG. 10 shows another example of an LED drive pulse according to the present embodiment;

FIG. 11 is a chromaticity diagram showing a relationship between an input video signal and a chromaticity point in a liquid crystal panel;

FIG. 12 is a chromaticity diagram illustrating how to determine a look-up table according to the present embodiment;

FIG. 13A is a linear diagram for illustrating how to determine a look-up table according to the present embodiment, extracting line 1 shown in FIG. 12;

FIG. 13B is a linear diagram illustrating how to determine a look-up table according to the present embodiment, extracting line 2 shown in FIG. 12;

FIG. 14 is a block diagram showing a configuration of a liquid crystal display apparatus according to Embodiment 2 of the present invention; and

FIG. 15 is a block diagram showing a configuration of a liquid crystal display apparatus according to Embodiment 3 of the present invention.

### DESCRIPTION OF EMBODIMENTS

Hereinafter, embodiments of the present invention will be explained in detail with reference to the accompanying drawings.

Here, some of the terminology will be explained first. To be precise, “color temperature” is defined with respect to the chromaticity on the blackbody trajectory. However, for example, with liquid crystal display apparatuses, the chromaticity on an isotemperature line when backlight light sources emit white light or a liquid crystal display panel displays white color, is generally expressed as “color temperature of 9000 k” (to be more precise, “correlated color temperature”). Accordingly, light sources having the same color temperature of 9000 K do not necessarily have the same chromaticity. If the chromaticity is different, the way a color looks changes, that is, the way tinge (i.e. a fine hue in a medium such as a video image) looks changes. As will be described later, the present invention can adjust the chromaticity of white light in the range of the two-dimension of the chromaticity diagram. Hereinafter, assume that “chromaticity” refers to “the chromaticity of white light” in particular.

### Embodiment 1

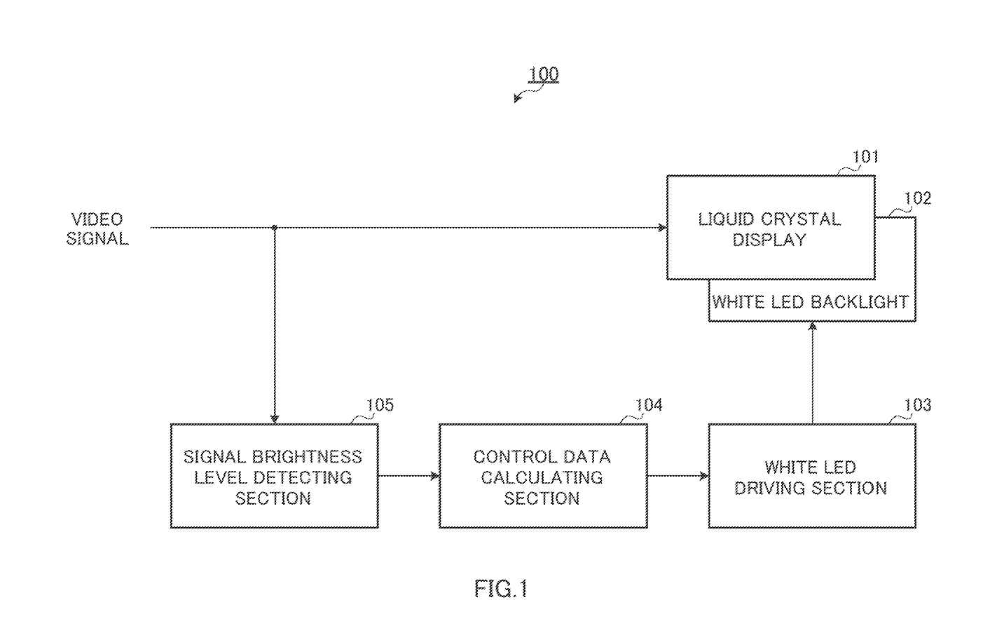

FIG. 1 is a block diagram showing a configuration of a liquid crystal display apparatus according to Embodiment 1 of the present invention.

Liquid crystal display apparatus 100 shown in FIG. 1 has liquid crystal panel 101, white LED backlight 102, white LED driving section 103, control data calculating section 104 and signal brightness level detecting section 105.

Liquid crystal panel 101 is a transmissive or semi-transmissive liquid crystal panel. Liquid crystal panel 101 allows transmission of light emitted from white LED backlight 102, and emits this transmission light from the front surface of the display screen. At this time, a liquid crystal driving section (not shown) controls the drive voltage that drives liquid crystal panel 101 based on a video signal. The video signal is a digital signal showing an image to be displayed on the display screen of liquid crystal panel 101. Thus, the transmittance of liquid crystal panel 101 is controlled. As a result of this control, liquid crystal panel 101 displays images.

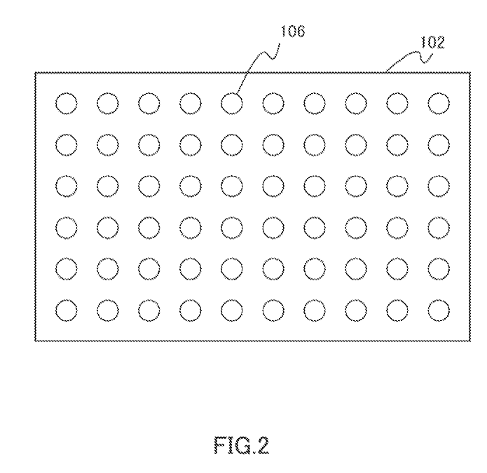

As shown in, for example, FIG. 2, white LED backlight 102 has multiple white LED's 106. White LED backlight 102 is a subjacent model backlight apparatus that arrays these multiple white LED's 106 virtually flat on the substrate and orients them toward the back surface of liquid crystal panel 101. White LED backlight 102 is provided on the back surface side of liquid crystal panel 101 and illuminates liquid crystal panel 101 by white light emitted from white LED's 106.

By the way, white LED backlight 102 is not limited to the subjacent model, and may be an edge light model backlight apparatus.

Generally, an LED changes its emission spectrum according to the drive current value. Hence, generally, the brightness is changed while maintaining the emission spectrum, that is, while maintaining emission color, by changing the duty cycle of the drive current using the PWM (Pulse Width Modulation) drive scheme.

In case where a plurality of colors of LEDs such as red, green and blue are blended to realize white color, it is possible to adjust the chromaticity of white color by changing the brightness ratio of LEDs to blend. In this case, it is possible to adjust the chromaticity of white light only by adjusting the duty cycle of LEDs of each color without changing the overall brightness.

White LED 106 is an LED unit having mainly a monochromatic (for example, blue) LED and a fluorescent material. White LED 106 is driven by a drive pulse applied from white LED driving section 103 and emits white light. That is, white LED 106 is configured such that light emitted from a monochromatic LED when a drive pulse is applied, passes through the fluorescent material and becomes white light through the action of this fluorescent material.

However, with such white LED 106, it is not possible to adjust the chromaticity by adjusting the blend ratios of LEDs having various emission spectra. This is because, even if the duty cycle of monochromatic excitation light is changed, only the average brightness to observe changes.

In another patent application, to adjust color temperature (i.e. chromaticity) in such a white LED, the applicants of the present invention have proposed adjusting color temperature (i.e. chromaticity) by changing the current value (i.e. wave height value of a pulse) in contrast to the general technique and covering the resulting changes in brightness by adjusting the duty cycle. Further, in the above another patent application, the applicants of the present invention have disclosed that it is possible to actively utilize changes in brightness caused by changing the current value, depending on the state of a video signal or ambient light.

The liquid crystal display apparatus according to the present invention can adjust the color temperature adjustment range disclosed in the above another patent application, and, in addition, the chromaticity in a wide range, and suppress changes in brightness upon chromaticity adjustment without adjusting duty cycles. Further, as will be described later, the liquid crystal display apparatus according to the present invention is superior in the resolution of brightness adjustment for video signals.

Further, with the present embodiment, although white LED 106 is an LED unit that employs a configuration including a monochromatic LED and fluorescent material to emit white light, the present invention is not limited to this, and white LED 106 may be an LED unit that employs other configurations to emit white light. Further, the present invention is also applicable to LEDs other than white LEDs.

Signal brightness level detecting section 105 functions as a detecting section. Signal brightness level detecting section 105 is a circuit that detects the average brightness level (APL: average picture level) as the feature amount of a video signal.

Further, in addition to the average brightness level or instead of the average brightness level, signal brightness level detecting section 105 may detect brightness levels such as the maximum brightness level (MAX) and the minimum brightness level (MIN) as the feature amount. In this case, signal brightness level detecting section 105 may detect the area or position of the portion in an image where the brightness level is maximum or minimum.

Control data calculating section 104 functions as a controlling section. Control data calculating section 104 is a calculation processing circuit that calculates current values, pulse widths and pulse switching times of a plurality of pulses forming a drive pulse (described later) for white LED 106 based on the feature amount detected in signal brightness level detecting section 105 in order to control the chromaticity of white LED backlight 102. Control data calculating section 104 generates control data indicating the calculated current values, pulse widths and pulse switching times, and outputs the generated control data to white LED driving section 103.

White LED driving section 103 functions as a driving section. White LED driving section 103 is a circuit that generates drive pulses for driving white LED's 106 according to control data outputted from control data calculating section 104, and applies the generated drive pulses to white LED's 106.

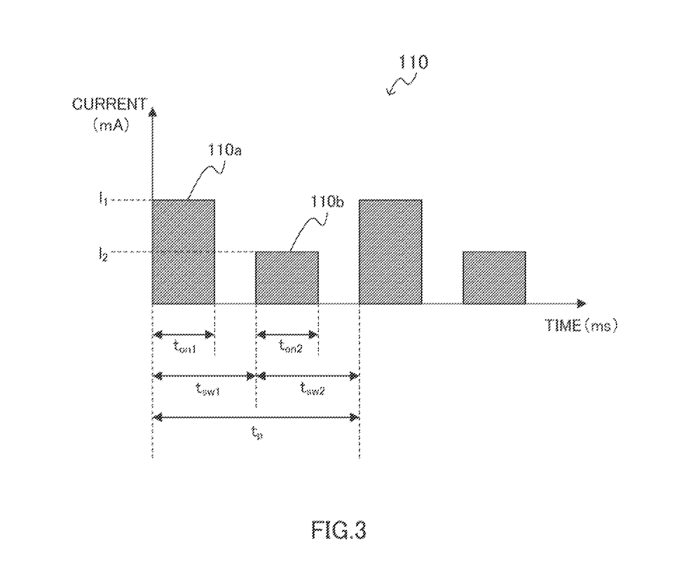

FIG. 3 shows an example of a drive pulse of a white LED generated by white LED driving section 103.

With the present embodiment, a drive pulse of a white LED is formed by combining a plurality of pulses of different current values (hereinafter “constituent pulses”). For example, drive pulse 110 shown in FIG. 3 is formed by combining two rectangular pulses 110a and 110b as constituent pulses. Rectangular pulses 110a and 110b each have a waveform with current value I and duty cycle D (%) (=pulse width t_{ON}/pulse switching time t_{SW}). At least current value I varies between two rectangular pulses 110a and 110b. To be more specific, rectangular pulse 110a has current value I₁ and duty cycle D₁(%) (=pulse width t_{ON1}/pulse switching time t_{SW1}), and rectangular pulse 110b has current value I₂ and duty cycle D₂(%) (=pulse width t_{ON2}/pulse switching time t_{SW2}) (I₁≠I₂). With the example shown in FIG. 3, two rectangular pulses 110a and 110b are alternately repeated periodically to make the period as a whole t_{P} (=t_{SW1}+t_{SW2}).

Note that current value I of one of two rectangular pulses 110a and 110b may be zero. By contrast, two rectangular pulses may be a result of a control, and are not necessarily different as shown in FIG. 3. Further, a white LED drive pulse may be formed by combining three or more rectangular pulses.

The configuration of liquid crystal display apparatus 100 has been explained above.

Next, the operation of an LED drive pulse control in liquid crystal display apparatus 100 employing the above configuration will be explained. Here, a case will be explained as an example where the average brightness level of a video signal is the feature amount to be detected and drive pulse 110 shown in FIG. 3 is the drive pulse for white LED's 106 to be controlled.

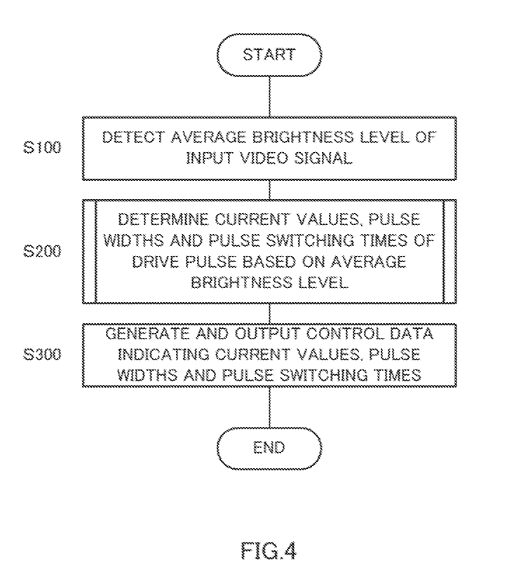

FIG. 4 is a flowchart showing an example of an LED drive pulse control in liquid crystal display apparatus 100.

First, in step S100, signal brightness level detecting section 105 acquires a video signal inputted in the liquid crystal driving section (not shown) in liquid crystal panel 101, and detects the average brightness level (APL) of the acquired video signal.

Then, in step S200, control data calculating section 104 determines current values I (I₁ and I₂), pulse widths t_{ON} (t_{ON1} and t_{ON2}) and pulse switching times t_{SW} (t_{SW1} and t_{SW2}) of a plurality of pulses (i.e. rectangular pulses 110a and 110b) forming drive pulse 110, based on the average brightness level detected in step S100. Details will be described later.

Then, in step S300, control data calculating section 104 generates control data indicating current values I (I₁ and I₂), pulse widths t_{ON} (t_{ON1} and t_{ON2}) and pulse switching times t_{SW} (t_{SW1} and t_{SW2}) of a plurality of pulses (i.e. rectangular pulses 110a and 110b) determined in step S200, and outputs the generated control data to white LED driving section 103.

By this means, according to the control data outputted from control data calculating section 104, white LED driving section 103 generates drive pulse 110 formed with a plurality of pulses (i.e. rectangular pulses 110a and 110b) in which at least current values I are different (note that there are cases where current values I transiently become the same, depending on the state of APL).

By controlling current values I and duty cycles D (=pulse width t_{ON}/pulse switching time t_{SW}) of a plurality of pulses forming drive pulse 110 in this way, it is possible to control the chromaticity and brightness of white LED backlight 102 flexibly at the same time.

Here, processing in above step S200 of FIG. 4 will be explained in more detail using FIG. 5. FIG. 5 is a flowchart showing content of processing in step S200 of FIG. 4.

In step S201, control data calculating section 104 determines the chromaticity and brightness of white LED backlight 102 based on the average brightness level detected in step S100. The chromaticity of white LED backlight 102 is determined taking tinge into account such that the color temperature is higher when the average brightness level is higher and the color temperature is lower when the average brightness level is lower. To be more specific, the chromaticity on the isotemperature line is specified from information about tinge.

Then, in step S202, control data calculating section 104 determines each current value I (that is, the combination of current values I) and the blend ratio for drive pulse 110, based on the chromaticity determined in step S201 and some conditions. The blend ratio is defined as the ratio of the products of current values I and pulse switching times t_{SW} of pulses forming drive pulse 110. Drive pulse 110 shown in FIG. 3 is formed with two different rectangular pulses 110a and 110b as described above. In this case, the blend ratio for drive pulse 110 is represented approximately by the ratio of (I₁×t_{SW1}):(I₂×t_{SW2}) if the relationship between the drive current and the emission efficiency of an LED is ignored.

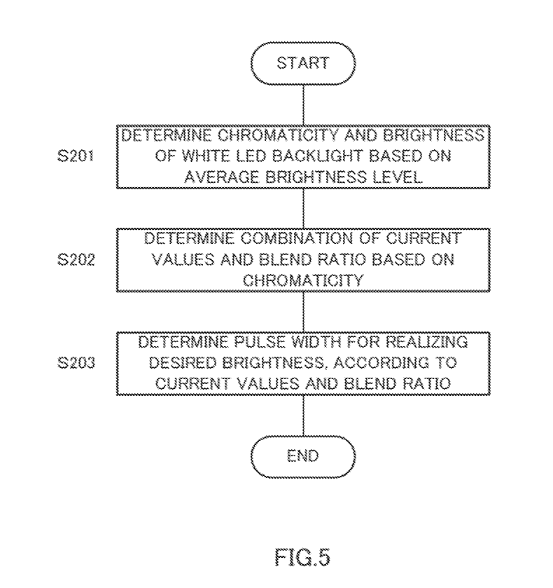

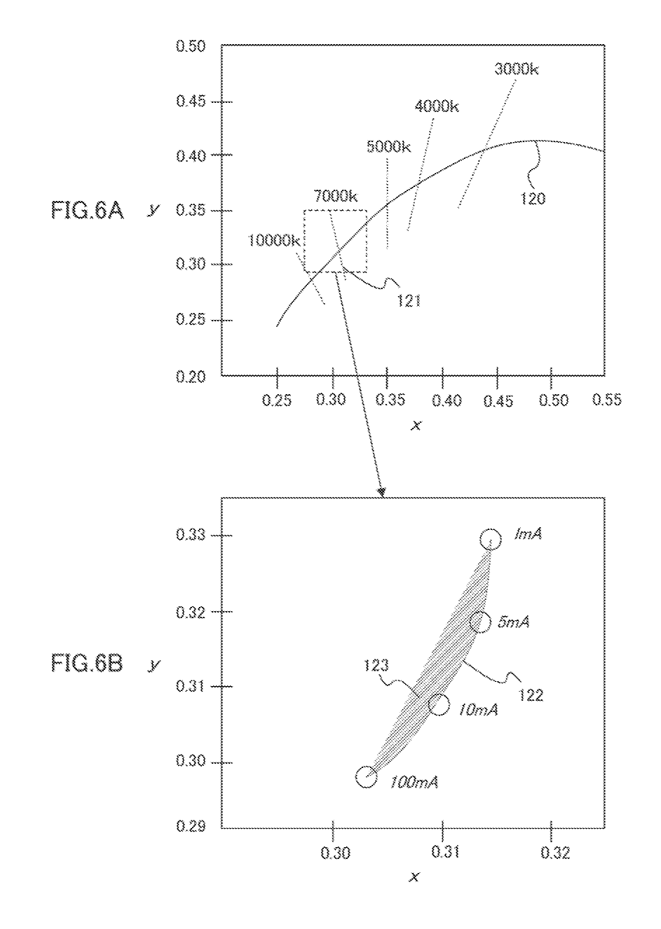

FIG. 6 is a chromaticity diagram showing the chromaticity adjustment range and a blackbody trajectory of a white LED. Particularly, FIG. 6A shows a blackbody trajectory and an isotemperature line in an xy chromaticity diagram, and FIG. 6B shows a chromaticity adjustment range of a white LED. As shown in FIG. 6A, black trajectory 120 and each isotemperature line 121 intersect in the xy chromaticity diagram.

A popular white LED changes the chromaticity according to the drive current, in, for example, the range shown in FIG. 6B (to be more specific, in the shaded range indicated by diagonal lines including the curve of the solid line). Here, a white LED assumes a white LED that uses a YAG fluorescent material as a fluorescent material. This white LED has characteristics that the color temperature is lower (that is, the chromaticity point approaches closer to the red area) when drive current value I is lower, and the color temperature is higher when drive current value I is higher (that is, the chromaticity point approaches closer to the blue area).

Further, in case where the fluorescent material is a silicate fluorescent material (for example, Eu2+activated alkaline earth metal orthosilicate), white LED 106 has characteristics that the color temperature is lower when drive current value I is higher (that is, the chromaticity point approaches closer to the red area), and the color temperature is higher when drive current value I is lower (that is, the chromaticity point approaches closer to the blue area).

Then, in case where a white LED is driven by a drive pulse having a single current value, the chromaticity of a white LED follows trajectory 122 of the solid line shown in FIG. 6B as disclosed in the above another patent application. That is, trajectory 122 of the solid line shown in FIG. 6B is the trajectory of the chromaticity that the drive pulse having a single current value may have. However, as in the present embodiment, in case where a white LED is driven by a drive pulse having a plurality of current values, a white LED may have the chromaticity in shaded range 123 shown in FIG. 6B. That is, shaded range 123 shown in FIG. 6B is the area of the trajectory of the chromaticity that the drive pulse having a plurality of current values may have.

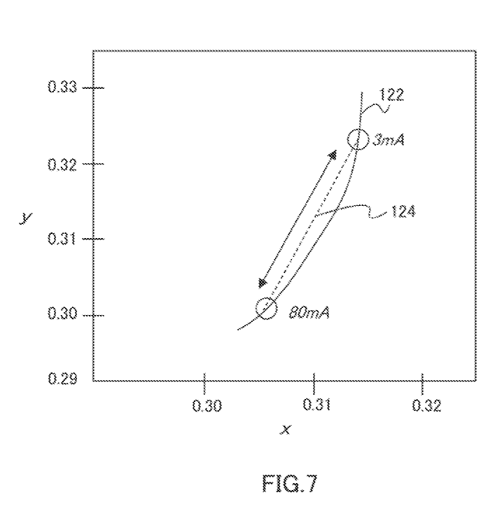

FIG. 7 is a chromaticity diagram showing an example of the relationship between an LED drive pulse current value and chromaticity. To be more specific, FIG. 7 shows the changes in chromaticity in case where, for example, a white LED using a YAG fluorescent material is driven by a drive pulse having current values of 3 mA and 80 mA.

With the example shown in FIG. 7, relative values of duty cycles of a pulse of 3 mA and a pulse of 80 mA are changed, so that the chromaticity moves on dotted line 124 in FIG. 7. A chromaticity point observed by human eyes is uniquely determined by the ratio of brightness of light emitted by a white LED when different currents (3 mA and 80 mA) are applied in a period in which the different current values alternately repeat. To be more specific, the midpoint of two chromaticity coordinates calculated using the emission brightness ratio of two current values as a weight, becomes the chromaticity point to observe. This is because, although light is emitted at different brightnesses in two chromaticity points in reality, if this occurs in a fast period, human eyes observe the average values of brightness and chromaticity. Further, with the example shown in FIG. 7, although two different pulses are combined, it is equally possible to combine three or more different pulses.

With the present embodiment, a drive pulse combining a plurality of pulses having different current values is repeated periodically. In case where the dependency of the LED emission efficiency on the drive current is approximately ignored, the brightness of an LED is determined based on the product of current value I and pulse width t_{ON}. Accordingly, different current values mean that brightness and chromaticity change every time each current value is switched. In case where a drive pulse is formed with two different pulses (see FIG. 3), this drive pulse is repeated periodically, so that given brightness and chromaticity change to different brightness and chromaticity and then return to the original brightness and chromaticity.

Generally, if this period is long, an effect of temporal average decreases. Accordingly, if this period is long, human eyes observe periodical changes in brightness and chromaticity as flickers, and causes negative influences upon health and so on. Therefore, although it depends on the difference in brightness and the difference in chromaticity in this period, the sum of switching times t_{SW} for the constituent pulses (that is, period t_{P} of the drive pulse) is preferably 20 milliseconds or less. This is because, if flickers converted into frequency are 50 Hz or more, the flickers are not likely to be observed. If this is applied to the example shown in FIG. 3, t_{SW1}+t_{SW2}=t_{P}≦20 ms.

Note that this assumes a case where drive pulse period t_{P} described above is driven while maintaining given desired brightness and chromaticity of white LED backlight 102 as a measure to prevent flickers. In reality, the desired chromaticity and brightness (this will be described later) change over time based on, for example, a video signal, and therefore the period of a drive pulse changes from time to time. In this case, generally, the brightness and chromaticity are changed optimally according to the condition and, consequently, they may be considered separately from flickers.

Back to the explanation of step S202, for example, in case where the fluorescent material in white LED 106 is a YAG fluorescent material, each current value I and pulse width t_{ON} are determined taking tinge into account, so that the average chromaticity is higher when the determined chromaticity of white LED backlight 102 is higher and the average chromaticity is lower when the determined chromaticity of white LED backlight 102 is lower. In case of drive pulse 110 shown in FIG. 3, the blend ratio is represented by the ratio of (I₁×t_{SW1}):(I₂×t_{SW2}) as described above.

Note that, strictly speaking, the electro-optic conversion efficiency of an LED changes according to current values and pulse width values, and therefore correction needs to be performed taking into account changes in the electro-optic conversion efficiency. For ease of explanation, the present embodiment will be explained without explaining correction that is performed taking into account changes in the electro-optic conversion efficiency of an LED.

Then, in step S203, controlling data calculating section 104 determines pulse width t_{ON} of drive pulse 100, according to each current value I and the blend ratio determined in step S202 so as to realize the determined brightness.

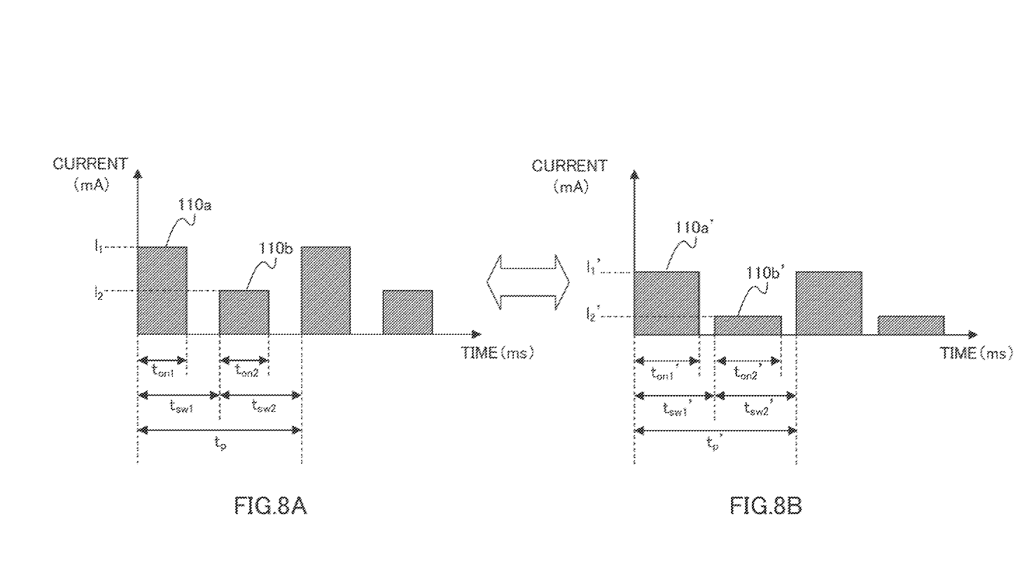

FIG. 8 illustrates a specific example of an LED drive pulse control. To be more specific, FIG. 8 shows an example of a drive pulse in which current value I and duty cycle D (=pulse width t_{ON}/pulse switching time t_{SW}) of each constituent pulse are altered according to the LED drive pulse control. FIG. 8A and FIG. 8B show images in case where a control is performed such that, for example, the average brightness is the same and the average chromaticity is different. Here, “average brightness” refers to “brightness” that is integrated to be observed by human eyes, and is different from the above average brightness level. Note, with the example shown in FIG. 8, pulse switching time t_{SW} and drive pulse period t_{P} of each constituent pulse is the same between FIG. 8A and FIG. 8B.

Here, a specific example of a practical controlling method (i.e. the reference for control) in above step S202 will be explained.

Assume that there is a drive pulse waveform that realizes certain chromaticity. In order to control brightness without changing the chromaticity to be realized, the duty cycle of each pulse only needs to be changed at a uniform rate. This is because chromaticity does not change if the blend ratio is not influenced. That is, the brightness is controlled by controlling the duty cycle according to the PWM drive scheme. Although the average brightness (which is proportional to the average current) in one period naturally increases if the duty cycle is increased, the average brightness is saturated when the duty cycle is 100 percent. Therefore, even if, for example, the desired chromaticity is realized by combining pulses having low current values, there may be cases where the desired brightness level is not satisfied. The same applies to the above another patent application. That is, to determine the waveform of a drive pulse in order to change the chromaticity, it is preferable to set restrictions related to brightness in advance so as to realize the desired brightness.

There are two patterns of setting restrictions related to brightness. Generally, the brightness of the backlight of a liquid crystal display is changed based on a video signal, ambient light and user setting. Assume that the minimum brightness and the maximum brightness that need to be realized are P_{MIN} and P_{MAX}, respectively, and the desired brightness that needs to be realized now is P_{NOW}. As restrictions related to brightness, there are an option of restriction 1 of “in the range in which P_{NOW} can be realized” and an option of restriction 2 of “in the range in which P_{MAX} can always be realized.” The former (i.e. restriction 1) of lower brightness provides more options of general shapes that a drive pulse can take although its restriction is loose. By contrast, the latter (i.e. restriction 2) provides better controllability although its restriction is severe. The reason is as follows.

Assume that the brightness is changed by a PWM control while maintaining the chromaticity. In this case, with the former (i.e. restriction 1), in case where the new brightness is greater than previous P_{NOW}, the general shape of a drive pulse needs to be changed (note that this is not the case in case where all of pulses forming this drive pulse are t_{ON}≠t_{SW}). Therefore, the former increases the number of times to calculate the desired chromaticity, thereby increasing the load. Further, due to the characteristics, the completely same chromaticity cannot necessarily be realized as before, and therefore there is a possibility that difference in chromaticity causes color flickers. By contrast, with the latter (restriction 2), to whichever brightness the brightness is changed, it is possible to realize all brightnesses from P_{MIN} to P_{MAX} by changing only duty cycles without changing the drive waveform. That is, the latter can reduce the calculation load and prevent occurrence of color flickers.

Accordingly, it is practical to select the waveform of a drive pulse by adding some conditions to these restrictions. As described above, for ease of explanation, each pulse forming a drive pulse of one period (t_{P}) is referred to as “constituent pulse.” As additional conditions to be set in a single drive pulse, there may be condition 1 that “switching time t_{SW} may vary between constituent pulses” and condition 2 that “switching time t_{SW} is the same between constituent pulses.” Further, as the condition to be set between drive pulses that realize different chromaticities although the brightnesses are the same, there may be condition 3 that “every parameter may vary between different drive pulses” and condition 4 that “only the current value varies between different drive pulses.”

Although the restriction related to options for drive waveforms that may be assumed is stronger in condition 2 than in condition 1, a control of switching the current value at regular intervals at all times, is performed with respect to a drive circuit, and therefore controllability improves. In addition, if the duty cycle of each constituent pulse is made the same, it is possible to make on/off timings of currents the same and, further, it is possible to remove, for example, an information storage register of constituent pulses.

Pursuing this further results in additionally adopting condition 4. In case where the switching timing of constituent pulses varies per chromaticity as in condition 3, if the brightness is changed in such a state according to the PWM control, there is a problem that the dynamic range of constituent pulses varies per chromaticity. If a drive pulse is digitally controlled, the pulse width can only be adjusted in predetermined width units. Accordingly, if chromaticity changes, the resolution of brightness adjustment changes. For example, if one drive signal has one-fourth of a pulse width compared to a drive signal having a given pulse width, its resolution of a pulse width control becomes one-fourth. Therefore, there is a problem that brightness gradation is rough in given chromaticity. However, in case where condition 2 and condition 4 are satisfied, only the current value of each constituent pulse changes even if chromaticity changes, so that it is possible to solve this problem.

It is possible to make condition 2 more specific. For example, the above flicker is prevented by determining period tp in the range of t_{P}≦20 ms and generating a drive pulse in one period using N types of pulses obtained by dividing tp by N. Further, all switching times t_{SW} of pulses are the same, so that N×t_{SW}=t_{P}. Here, as an additional condition, some current values may be the same between the current values of N pulses, or may be zero. By this means, it is possible to secure a wider chromaticity change range under these restrictions and conditions, and perform a control while maintaining a constant dynamic range. It is possible to provide the benefit of the latter even in case where changes in chromaticity with respect to the current value of a white LED is linear (that is, match the range of the chromaticity that may be assumed when a control is performed using a drive pulse having a single current value).

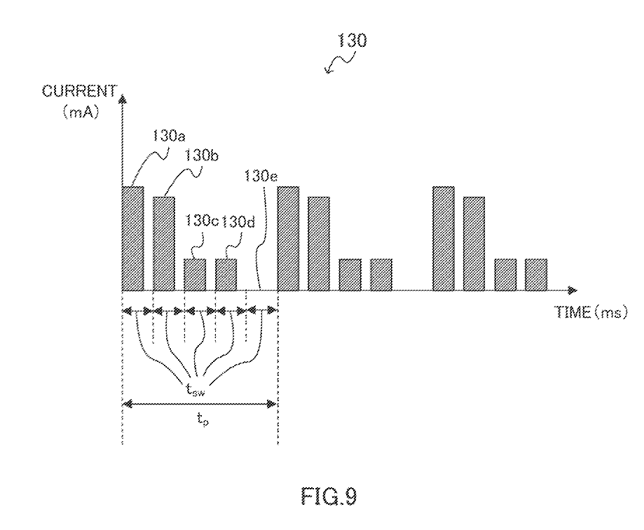

FIG. 9 shows another example of an LED drive pulse.

With the example shown in FIG. 9, a control is performed by dividing period t_{P} of drive pulse 130 by five. That is, drive pulse 130 is formed with five pulses 130a, 130b, 130c, 130d and 130e matching five equally-divided switching times t_{SW}. The current values of two pulses 130c and 130d forming drive pulse 130 are the same, and the current value of pulse 130e is zero. Further, all pulses 130a to 130d having greater current values than zero are driven at same duty cycle D (for example, 70 percent). This means that pulse widths t_{ON} and switching times t_{SW} are the same between all of four pulses 130a to 130d.

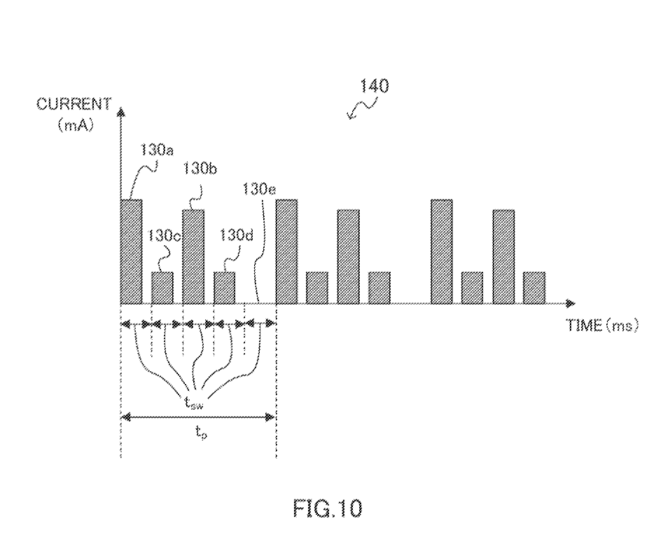

FIG. 10 shows another example of an LED drive pulse. To be more specific, FIG. 10 shows a case where the steps to generate part of pulses in the drive pulse shown in FIG. 9 are changed.

In drive pulse 140 shown in FIG. 10, two pulse 130b and 130c are changed in drive pulse 130 shown in FIG. 9. As shown in FIG. 10, by grouping a plurality of pulses (130a to 130d) forming a drive pulse into sets of pulses (a set of pulses 130a and 130b and a set of pulses 130c and 130d) having similar current values and by, for example, alternately arranging pulses belonging to each group, it is possible to indistinguishably make the period of the drive pulse shorter. By making human eyes sense indistinguishably that the period of the drive pulse is short, it is possible to reduce flickers. Further, grouping may provide three or more groups. Further, pulses belonging to each group may be arranged such that lower area frequency components of a ripple shift approximately to a high frequency side in case where a lowpass filter is applied to a drive pulse.

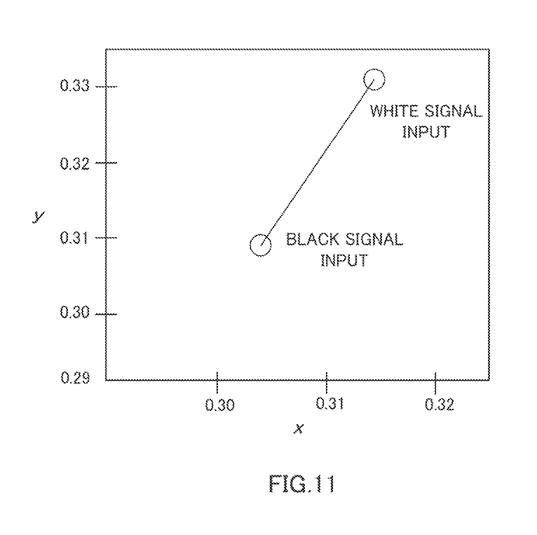

Here, improvement of a bluish tinge when black color is displayed on liquid crystal panel 101 will be explained using FIG. 11. FIG. 11 is a chromaticity diagram showing the relationship between an input video signal and a chromaticity point in a liquid crystal panel.

Generally, the chromaticity point approaches closer to the blue area when the color temperature is higher, and the chromaticity point approaches closer to the red area when the color temperature is lower. As shown in FIG. 11, the phenomenon that black color has a bluish tinge when black color is displayed on liquid crystal panel 101 means that the color temperature is higher when the brightness level of a video signal is lower, and the color temperature is lower when the brightness level of a video signal is higher. Accordingly, while, for example, the color temperature of a white LED is controlled lower when the brightness of a video signal is lower, the color temperature of a white LED is controlled higher when the brightness of a video signal is higher, so that it is possible to reduce changes in the color temperature caused by liquid crystal panel 101.

Further, while the brightness of a backlight is controlled higher when the brightness of a video signal is higher, the brightness of a backlight is controlled lower when the brightness of a video signal is lower to change the chromaticity of the backlight according to the brightness of a video signal, so that it is possible to improve contrast of an image displayed on liquid crystal panel 101. In case where this control is not performed, white LED backlight 102 is controlled so as to change the chromaticity without changing the brightness, according to the average brightness level of an image signal. The same applies to a case where a user setting value is read to simply change the chromaticity.

Note that, in case where white LED backlight 102 is a subjacent backlight apparatus, it is more advantageous to group arrayed multiple white LEDs 106 on a per area basis, and perform an LED drive pulse control of the present embodiment per LED 106 group. This is because it is possible to optimize the chromaticity and brightness of a display image on a per area basis by performing a brightness control and a color temperature control on a per area basis.

Further, pursuing this further also makes it possible to enhance the color reproduction performance of liquid crystal panel 101 taking into account the chromaticity of a video signal. Further, in addition to images, by applying the control of the present embodiment to changes in chromaticity or changes in brightness due to fluctuation of characteristics of a white LED itself caused by changes in temperature or secular changes, it is possible to reduce changes in chromaticity and changes in brightness. In this case, a temperature sensor or color sensor is provided inside a liquid crystal backlight apparatus.

Further, although not shown, it is equally possible to adjust video signals based on outputs of signal brightness level detecting section 105 or control data calculating section 104 and input the signals to liquid crystal panel 101.

In case where the above algorithm is implemented, the chromaticity to be realized for each average brightness level and parameters related to a drive pulse for reproducing its chromaticity, are provided in a look-up table (“LUT”). Then, it is practical to determine the chromaticity and parameters of a drive pulse while selecting or, where necessary, interpolating data having values closer to the desired value, from data that exist discretely.

This will be explained in detail below.

The basic configuration will be explained first.

With the present scheme, a look-up table (not shown) is provided. Then, the chromaticity to be realized is determined in advance on a per average brightness level basis, and parameters (e.g. parameters of a repetitive pulse group of current values and switching times) related to a drive pulse for reproducing this chromaticity are also calculated in advance. Note that the look-up table is stored in the memory (not shown) of liquid crystal display apparatus 100.

At this time, as methods of determining parameters to actually use, there are two options of (1) providing data of X brightness levels, in the look-up table and discretely adjusting the parameters to actually use, at X levels and (2) providing data of X brightness levels, in the look-up table and interpolating parameters to actually use, by linear interpolation or spline interpolation in case where a brightness level between two brightness levels is observed. The former is not costly but does not allow smooth color temperature adjustment. By contrast with this, the latter is costly, but allows smooth color temperature adjustment.

In case of the former (i.e. determination method (1)), in the flowchart of FIG. 5, the following processing is performed in addition to the above processing or the following processing is performed, as described below in more details.

In step S201, the desired chromaticity is calculated from the average brightness-desired chromaticity function provided inside, based on the average brightness level observed in step S100. Then, the chromaticity closest to the desired chromaticity is selected from chromaticities on the look-up table. The brightness is determined based on at least one of the average brightness level and user setting. As described above, in case of dark images, the brightness may be determined by further decreasing the brightness of the backlight to improve contrast more, or may be determined based on the backlight brightness setting value of the user setting.

Thus, in step S202, parameters related to current values and switching times matching the selected chromaticity have already been held in the memory (i.e. look-up table), and therefore are read from the memory.

Then, in step S203, the pulse width of each constituent pulse is determined to realize the desired brightness while maintaining the chromaticity, that is, while maintaining the ratio of the pulse width and the current value of each constituent pulse. That is, the blend ratio is determined.

In case of the latter (i.e. determination method (2)), in the flowchart of FIG. 5, the following processing is performed in addition to the above processing, or the following processing is performed, as described below in more details.

In step S201, the desired chromaticity is calculated from the average brightness-desired chromaticity function provided inside, based on the average brightness level detected in step S100. Then, the chromaticity closest to the desired chromaticity is selected from the interpolated curve connecting chromaticity points successively on the look-up table. Further, the desired brightness is determined as in determination method (1).

Then, in step S202, parameters related to the current values and switching times matching the selected chromaticity are calculated by interpolating “chromaticity-parameter” data held on the memory (i.e. look-up table).

Then, in step S203, the pulse width of each constituent pulse is determined to realize the desired brightness while maintaining the chromaticity, that is, while maintaining the ratio of the pulse width and the current value of each constituent pulse. That is, the blend ratio is determined.

Note that “average brightness-desired chromaticity function” in the above is an input/output function that associates the average brightness and chromaticity on a one-by-one basis. Further, the processings in step S202 may be combined as one processing to perform calculation directly from the average brightness. Furthermore, in case where the parameters are acquired by interpolation, it is necessary to bear in mind that the current value and pulse change discontinuously in the border between the range of a given chromaticity and the range of another chromaticity.

Next, how the look-up table is determined will be explained.

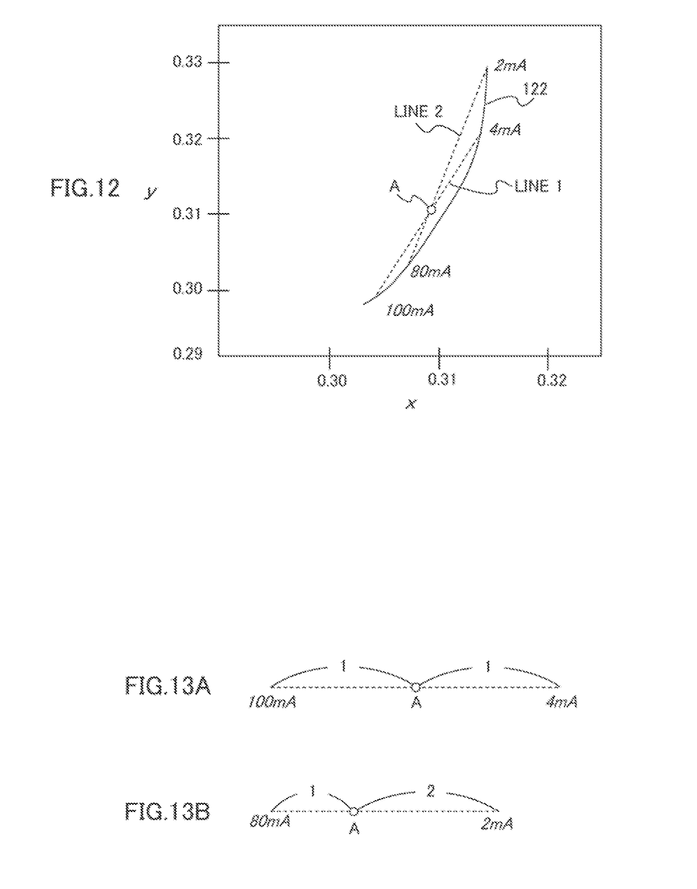

Hereinafter, an example of how parameters matching a given chromaticity in the look-up table are determined will be explained using FIG. 12 and FIG. 13. FIG. 12 is a chromaticity diagram for illustrating how to determine the look-up table, and FIG. 13 is a linear diagram for illustrating how to determine the look-up table.

With this example, above restriction 2, condition 1 and condition 3 are adopted, and, in addition to these, three of condition 5 of “using a combination of pulses of two kinds of wave height values,” condition 6 of “prioritizing the combination of similar two pulse widths” and condition 7 of “t_{P}≦20 ms” are set. Condition 6 is adopted because, if the pulse widths are similar, the difference in the resolution upon a PWM control is not likely to be distinct.

With this example, assume that chromaticity A shown in FIG. 12 needs to be realized. A plurality of lines shown in FIG. 12 (for example, line 1 and line 2) that pass chromaticity A and that have the start point and end point on trajectory 122 (i.e. curve of the solid line) of the chromaticity that a drive pulse having a single current value may have. Here, line 2 is more preferable than line 1 in view of condition 6. This reason is as follows.

FIG. 13A and FIG. 13B show line 1 and line 2, respectively, extracted from FIG. 12. With respect to the chromaticities that are realized by the current values, the position of chromaticity A that needs to be realized is 1:1 in FIG. 13A and is 1:2 in FIG. 13B. This means that, as is obvious mathematically, the brightness ratio between 100 mA and 4 mA needs to be set to 1:1 which is the inverse ratio of 1:1, and the brightness ratio between 80 mA and 2 mA needs to be set to 2:1. In this case, assuming that the pulse width of the higher current value is 1, the pulse width of the lower current value is 25 in FIGS. 13A and 20 in FIG. 13B. Accordingly, FIG. 13B, that is, line 2, is more preferable in view of condition 6.

Next, according to restriction 2 and condition 7, it is checked whether or not the brightness of P_{MAX} can be achieved before period t_{P} reaches 20 ms when the pulse width is increased while maintaining the ratio of the pulse widths of two constituent pulses. If this check is cleared, the constituent pulses of 80 mA and 2 mA (where the pulse width ratio is 1:20) are employed. Then, assuming that each pulse width when the brightness reaches P_{MAX}, is made a pulse switching time, the pulse width is PWM-controlled while maintaining the pulse width ratio to realize the desired brightness. By contrast with this, if that check is not cleared, a new combination is searched for again. A new combination is searched for again by setting priority to conditions and restrictions in advance, and adopting the combination of line 1 in this case if the combination of line 1 meets restriction 2 and condition 7.

A look-up table is determined in this way.

As described above, according to the present embodiment, by increasing or decreasing a plurality of current values I of a drive pulse of white LED 106 in white LED backlight 102, the chromaticity of the white LED backlight is altered. By this means, in case where a light source is a white LED backlight, it is possible to alter the chromaticity of a display image by performing a drive control of the light source. Further, it is possible to control the brightness while maintaining the chromaticity.

Generally, the white LED backlight differs from a fluorescent tube in controlling chromaticity by controlling driving of the white LED backlight. However, altering the chromaticity of the backlight is not necessarily desirable when the influence upon a display image is taken into account. Therefore, with a liquid crystal display apparatus having a white LED backlight, only duty cycle D of a drive pulse is altered to alter the brightness of the backlight, and current values of a drive pulse are generally fixed or controlled so as not to change the chromaticity of the backlight. By contrast with this, the present embodiment positively alters current values of a drive pulse, which overturns conventional technical knowledge in the drive control of the white LED backlight. Consequently, it is naturally possible to control the brightness of light sources as in conventional art, and it is possible to provide a special advantage of performing at the same time a brightness control and a chromaticity control that is effective to correct a bluish tinge in black color in a display image.

Further, although a case has been described where the light sources are white LEDs, the present embodiment is applicable to all light sources that change their chromaticities according to current values. Monochromatic LEDs such as red, blue or green, or laser light sources are examples of these light sources. Even if a configuration is employed where white color is realized by blending a plurality of wavelengths (i.e. colors), according to the present embodiment, it is possible to adjust the chromaticity of each light source itself that realize white color, in a certain range. Consequently, it is also possible to adjust the chromaticity of white light, which is the result of blending a plurality of wavelengths, and further expand the chromaticity adjustment range of white light that needs to be adjusted when the blend ratio changes.

### Embodiment 2

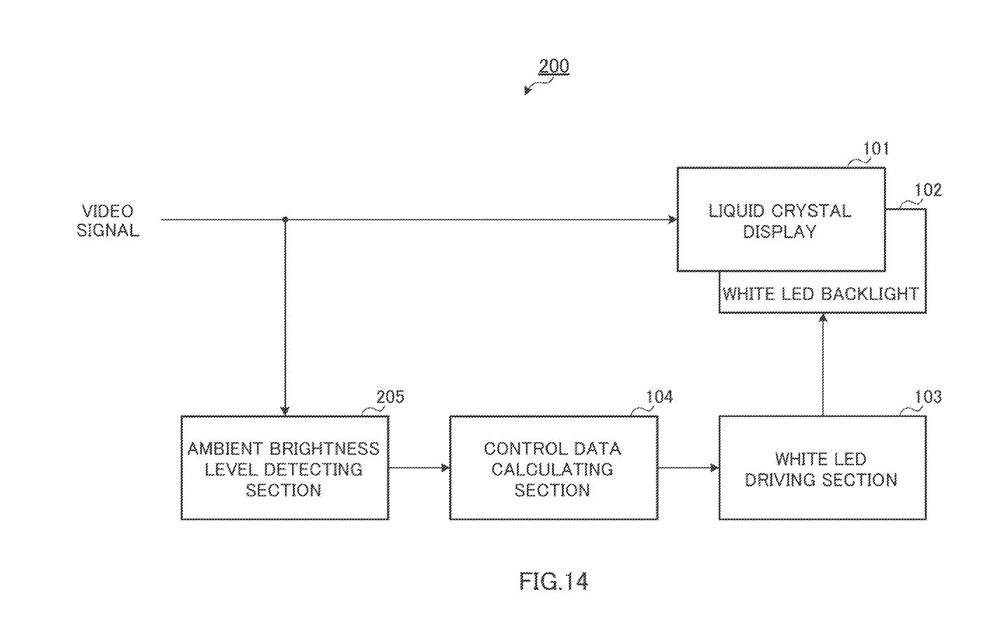

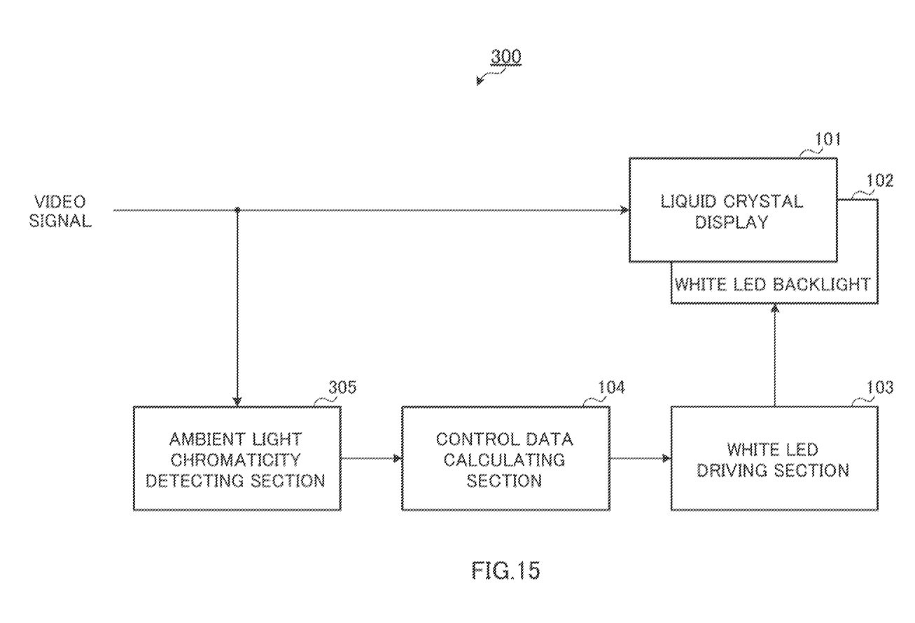

FIG. 14 is a block diagram showing a configuration of a liquid crystal display apparatus according to Embodiment 2 of the present invention. With liquid crystal display apparatus 200 shown in FIG. 14, the same components as in liquid crystal display apparatus 100 shown in FIG. 1 will be assigned the same reference numerals, and the detailed explanation thereof will be omitted.

Liquid crystal display apparatus 200 differs from liquid crystal display apparatus 100 shown in FIG. 1 in the configuration including ambient brightness level detecting section 205 instead of signal brightness level detecting section 105.

Ambient brightness level detecting section 205 is a sensor that detects, as the feature amount of ambient light, the brightness level of ambient light in an environment where liquid crystal display apparatus 200 is set. A photosensor is an example of this sensor. This photosensor is provided in, for example, the liquid crystal panel side of liquid crystal display apparatus 200.

While, with Embodiment 1, an LED drive pulse control is performed based on the feature amount of a video signal, with the present embodiment, an LED drive pulse control is performed based on the feature amount of ambient light. The rest of the details of the present embodiment are the same as in Embodiment 1, and therefore detailed explanation thereof will be omitted. To add a note regarding the determination of brightness, it is preferable to control the brightness of the backlight in proportional (either linearly or non-linearly) to the level of detected ambient light. This is because, if the brightness of the backlight is lowered and the brightness of an image to be displayed is lowered, the characteristics of human eyes allow human eyes to see a liquid crystal display apparatus in a dark place more easily.

Further, similar to Embodiment 1, although not shown, it is equally possible to adjust video signals based on outputs from ambient brightness level detecting section 205 or control data calculating section 104, and input the signals to liquid crystal panel 101.

As described above, an LED drive pulse control is performed based on the feature amount of ambient light according to the present embodiment. Although, for example, the bluish tinge in black color, which is blended in ambient light, becomes more distinct when the brightness level of ambient light is lower, an LED drive pulse control for lowering the color temperature of white LED backlight 102 is performed with the present embodiment. Further, when the brightness level of ambient light is high, an LED drive pulse control for raising the color temperature of white LED backlight 102 is performed. Consequently, with the present embodiment, when the brightness level of ambient light is high, it is possible to display white that shines blue, which is generally popular, on the display screen and, when the brightness level of ambient light is low, it is possible to display black color with a contained bluish tinge, on the display screen.

Moreover, it is possible to appropriately combine the configuration of liquid crystal display apparatus 100 of Embodiment 1 with the configuration of liquid crystal display apparatus 200.

### Embodiment 3

FIG. 15 is a block diagram showing a configuration of a liquid crystal display apparatus according to Embodiment 3 of the present invention. With liquid crystal display apparatus 300 shown in FIG. 15, the same components as in liquid crystal display apparatus 100 shown in FIG. 1 will be assigned the same reference numerals, and the detailed explanation thereof will be omitted.

Liquid crystal display apparatus 300 differs from liquid crystal display apparatus 100 shown in FIG. 1 in the configuration including ambient light chromaticity detecting section 305 instead of signal brightness level detecting section 105.

Ambient light chromaticity detecting section 305 is a sensor that detects, as the feature amount of ambient light, the chromaticity of ambient light in an environment where liquid crystal display apparatus 300 is set. A color sensor is an example of this sensor. This color sensor is provided in, for example, the liquid crystal panel 101 side of liquid crystal display apparatus 300. The color sensor detects the brightness level for each color of red, blue and green, and, as a result, can produce the brightness and chromaticity of blended light.

While an LED drive pulse control is performed based on the feature amount of a video signal with Embodiment 1, an LED drive pulse control is performed based on the feature amount of ambient light with the present embodiment. The rest of the details of the present embodiment are the same as in Embodiment 1, and therefore detailed explanation thereof will be omitted.

Further, similar to Embodiment 1, although not shown, it is equally possible to adjust video signals based on outputs from ambient light chromaticity detecting section 305 or control data calculating section 104, and input the signals to liquid crystal panel 101.

As described above, an LED drive pulse control is performed based on the feature amount of ambient light according to the present embodiment. Although, for example, the bluish tinge in black color becomes more distinct when the brightness level of ambient light is lower, an LED drive pulse control for lowering the color temperature of white LED backlight 102 is performed with the present embodiment. Further, when the brightness level of ambient light is high, an LED drive pulse control for raising the color temperature of white LED backlight 102 is performed. In addition to this, the chromaticity of the white LED backlight is adjusted according to the chromaticity of the detected ambient light, so that the final target chromaticity is determined.

It is known how the color of an object looks varies depending on the chromaticity of light that illuminates this object. Similarly, how the image of liquid crystal display apparatus 300 looks varies depending on the chromaticity of ambient light. This is due to the result of blending ambient light, reflected light of the ambient light reflected on the surface of liquid crystal panel 101, and image light from liquid crystal display apparatus 300. Accordingly, it is possible to display optimal images by adjusting the chromaticity of a white LED backlight according to the chromaticity of the detected ambient light.

Further, it is possible to adequately combine the configuration of liquid crystal display apparatus 100 according to Embodiment 1 with the configuration of liquid crystal display apparatus 300.

Embodiments of the present invention have been explained.

Note that the above explanation is an illustration of a preferable embodiment of the present invention, and the scope of the present invention is not limited to this. That is, the configuration of the above apparatus and the operation thereof upon use have been explained simply as examples, and it is obvious that various changes and additions are possible with respect to these examples within the scope of the present invention.

### INDUSTRIAL APPLICABILITY

The liquid crystal display apparatus according to the present invention can be utilized as a liquid crystal display apparatus such as a liquid crystal television or liquid crystal monitor.

### REFERENCE SIGNS LIST

100, 200, 300 LIQUID CRYSTAL DISPLAY APPARATUS
101 LIQUID CRYSTAL PANEL
102 WHITE LED BACKLIGHT
103 WHITE LED DRIVING SECTION
104 CONTROL DATA CALCULATING SECTION
105 SIGNAL BRIGHTNESS LEVEL DETECTING SECTION
205 AMBIENT BRIGHTNESS LEVEL DETECTING SECTION
305 AMBIENT LIGHT CHROMATICITY DETECTING SECTION

1. A liquid crystal display apparatus comprising:
a liquid crystal panel that displays an image;
a backlight that comprises a semiconductor light source and that illuminates the liquid crystal panel;
a driving section that drives the semiconductor light source;
a controlling section that controls the driving section so as to realize a desired, temporally-averaged chromaticity by switching between a plurality of chromaticities per switching time; and
a detecting section that detects a feature amount of at least one of the image, the semiconductor light source and ambient light,
wherein the controlling section controls at least one of chromaticity and brightness according to the feature amount detected by the detecting section.

2. The liquid crystal display apparatus according to claim 1, wherein the semiconductor light source is a light emitting diode.

3. The liquid crystal display apparatus according to claim 1, wherein the semiconductor light source is a semiconductor laser.

4. The liquid crystal display apparatus according to claim 2, wherein the light emitting diode is a white light emitting diode.

5. The liquid crystal display apparatus according to claim 1, wherein the plurality of chromaticities are realized by driving the semiconductor light source by a drive pulse formed by combining a plurality of pulses of different current values.

6. The liquid crystal display apparatus according to claim 5, wherein switching times are identical for all of the plurality of pulses.

7. The liquid crystal display apparatus according to claim 6, wherein duty cycles are identical for all of the plurality of pulses except for a pulse having a current value of zero.

8. The liquid crystal display apparatus according to claim 1, wherein a sum of switching times for the plurality of chromaticities is twenty milliseconds or less.

9. The liquid crystal display apparatus according to claim 5, wherein, to change the desired chromaticity, the controlling section performs a brightness maintaining control for maintaining a constant average brightness of the backlight.

10. The liquid crystal display apparatus according to claim 9, wherein the brightness maintaining control changes only each current value of the plurality of pulses.

11. The liquid crystal display apparatus according to claim 5, wherein, to change brightness, the controlling section performs a chromaticity maintaining control for maintaining a constant chromaticity.

12. The liquid crystal display apparatus according to claim 11, wherein the chromaticity maintaining control changes duty cycles of the plurality of pulses at a uniform rate, according to a pulse width modulation scheme.

13. The liquid crystal display apparatus according to claim 1, wherein the controlling section controls a color temperature of the backlight lower when an average brightness level of the image is lower, and controls the color temperature of the backlight higher when the average brightness level of the image is higher.

14. The liquid crystal display apparatus according to claim 1, wherein the controlling section controls brightness of the backlight lower when an average brightness level of the image is lower, and controls the brightness of the backlight higher when the average brightness level of the image is higher.

15. The liquid crystal display apparatus according to claim 1, wherein the controlling section controls a color temperature of the backlight lower when a brightness level of the ambient light is lower, and controls the color temperature of the backlight higher when the brightness level of the ambient light is higher.
